(19) United States
(12) Patent Application Publication
(10) Pub. No.: US 2010/0086253 A1
(43) Pub. Date: Apr. 8, 2010

(54) DISTRIBUTED TEMPERATURE SENSOR

(76) Inventors: Ophir Eyal, Ramat Ha-Sharon (IL); Moshe Liberman, Rishon-LeZion (IL)

Correspondence Address: EASTMAN KODAK COMPANY;PATENT LEGAL STAFF, 343 STATE STREET, ROCHESTER, NY, 14650-2201, US

(21) Appl. No.: 12/247,435

(22) Filed: Oct. 8, 2008

(51) Int. Cl. G02B 6/00; G01K 11/00

(52) U.S. Cl. 385/12; 374/161; 374/E11.015

(57) ABSTRACT

A distributed temperature sensor (10) for cables configurations including at least one optical waveguide (12), the waveguide is constructed from a material with a predefined melting point, a light source (13) which is configured to emit light into the sensing optical waveguide (12), end a detector (14) configured to detect transmitted light intensity from the sensing optical waveguide (12) and an interlock module (15) configured to perform a shutdown of high power fiber coupled laser diodes (11), according to the signal detected by detector (14).

### CROSS REFERENCE TO RELATED APPLICATIONS

Reference is made to commonly-assigned copending U.S. patent application Ser. No. 12/032,716, filed Feb. 18, 2008, and entitled A FIBER OPTIC IMAGING APPARATUS, by Eyal et al., the disclosure of which is incorporated herein.

### FIELD OF THE INVENTION

This present invention relates in general to a safety device for optical cables, and in particular to a distributed temperature sensor configured to alert on excess of heat.

### BACKGROUND OF THE INVENTION

There are a number of mechanical electrical devices that use optical fibers cables or electrical cables, collectively referred to as cables, wherein flexibility is especially important. In some applications, these cables are subjected to repetitive bending operations that may, over time, cause damage to the cables. This damage may cause electrical shorting, in the case of electrical cables, or melting of the cables due to light leakage and heat buildup, in the case of optical fiber. Both of these scenarios may cause safety issues and will certainly result in expensive repairs.

Printing machines present a good example of this type of problem. In a printing machine, a bundle of optical fiber is attached to a printing head, which is moved back and forth numerous times along a surface of a rotating drum to create an image on printing media attached to the drum.

Distributed temperature sensors have been used in the past to detect excess heat on different devices, for example along high power, electric transmission cables. One such device utilizes electrical wires, and is available, for example, from Protectowire (http://protectowire.com/). Electrical wires, however, are subjected to electrical noise and may provide false signals.

It is therefore the object of the present invention to provide a distributed heat sensitive sensor, flexible waveguide. It is also an object of the present invention to provide an alert module and an interlock module that are activated by a signal detected by the heat sensitive optical waveguide.

### SUMMARY OF THE INVENTION

Briefly, according to one aspect of the present invention a distributed temperature sensor for cable configurations includes at least one optical waveguide, the waveguide is constructed from a material with a predefined melting point. In addition a light source, which is configured to emit light into the optical waveguide, and a detector is configured to detect transmitted light intensity from the optical waveguide.

Plastic optical fibers used as longitudinal temperature sensor have several advantages over electrical wire detectors. Plastic optical fibers are more flexible, they are immune to electrical noise and their weight is low. Their flexibility is especially important in the case of printing machines where a bundle of optical fiber is moved numerous times along a rotating drum on which printing media is attached.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is an illustration of plastic fiber temperature sensor configuration wherein light source and light detector are located on the same side;

FIG. 2 is an illustration of plastic fiber temperature sensor configuration wherein light source and light detector are located on opposite sides; and

FIG. 3 is an illustration of plastic fiber temperature sensor configuration, utilizing a fiber optic coupler, and wherein the fiber tip is coated with a reflective coating enabling light to be back reflected into the fiber.

### DETAILED DESCRIPTION OF THE INVENTION

This invention presents methods and apparatus, for detecting heat excess situations within multi cable configurations. For example, when high power fiber coupled lasers are deployed, laser safety measures should be introduced to avoid hazardous states.

According to the present invention, a fiber optic, distributed, longitudinal temperature sensor will alert an operator on situations of excess of heat within and along a cable, such as a fiber optic bundle, electronic cables pipes, and similar cable configurations. For example, a fiber optic bundle is usually made of glass fibers and is configured to transmit light emitted from high power lasers. The excess heat generated within and along a bundle of fibers may be caused by a break or a cut along one or more locations of the glass fibers which form the bundle.

For purposes of illustration, a typical imaging device may use high power, fiber coupled laser diodes in its optical heads. The total optical power delivered by such a device is roughly 2000 watts. The usage of such power levels increases the need for caution so that hazardous situations do not occur. The cables should be carefully inspected to prevent light leakage or cable meltdown.

Excess heat will cause a sensing fiber, made from heat sensitive material such as plastic, to melt. As a result, a degradation or discontinuation will occur in the optical signal delivered via the sensing fiber. This degradation or discontinuation in the optical signal transmitted by the sensing fiber will cause an alarm and will activate an interlock that will shutdown the high power diodes. The time dependent degradation profile of the light level can be used for the signal. For example, an abrupt reduction in the light level will indicate excess heat, while a long-term degradation profile may indicate aging of the cables and reduction in the optical transmittance of the sensing fiber.

The heat sensitive fiber material will melt in high temperatures caused by the excess of heat. It can also melt as a result of direct high power laser radiation that is absorbed by the sensitive fiber. The heat sensitive fiber can be constructed in various ways. The type of materials and doping can be adjusted to fit a desired melting temperature. For example, polymers such as Polymethylmethacrylate (PMMA) maybe used. Different shapes and dimensions of the fiber's core, clad, and jacket may be used as well. For example, fibers that have only core, or fibers that have a photonic crystal structure can be selected. A plastic fiber safety sensor may be used simultaneously in conjunction with any other types of safety sensors that will alert an operator on the excess of generated heat.

Plastic optical fibers used as longitudinal temperature sensor have several advantages over similar devices that utilize electrical wires such as those available from Protectowire (http://protectowire.com/). Plastic optical fibers are more flexible, they are immune to electrical noise and their weight is low. Their flexibility is especially important in the case of printing machines where the bundle of optical fiber is moved numerous times along a rotating drum on which the printing media is attached.

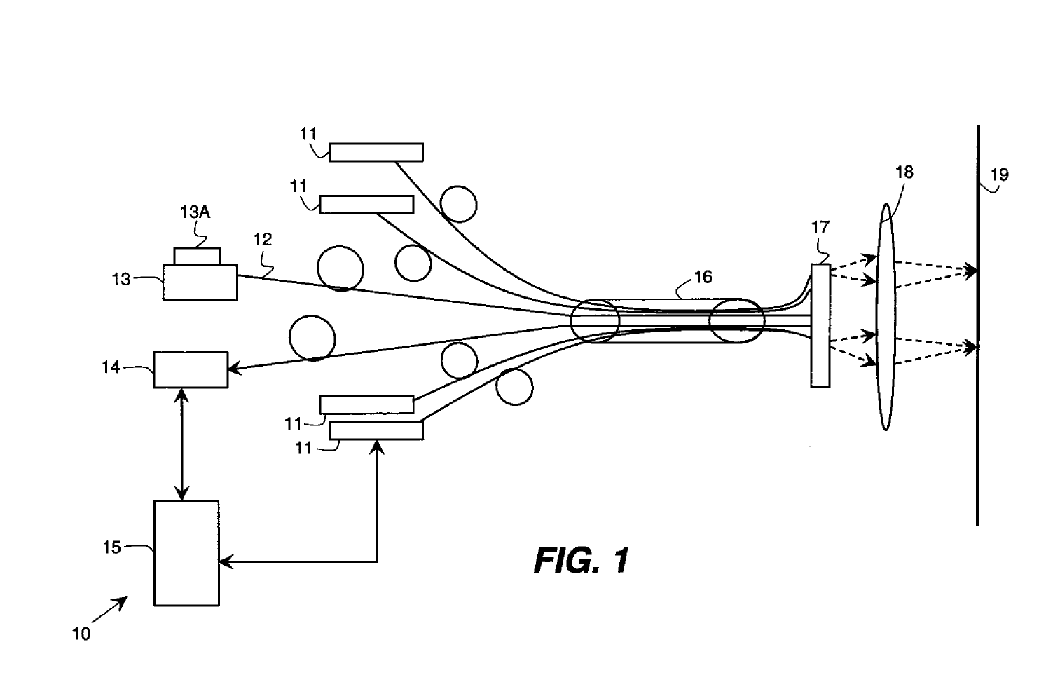

A preferred embodiment of a sensor is described in FIG. 1. The fiber bundle 16 comprises glass fibers coupled to high power laser diodes 11 is presented. The plastic optical sensing fiber 12 is incorporated as an integral part within or along the fiber bundle 16. The plastic optical sensing fiber 12 can be arranged in a U shaped configuration as is shown in FIG. 1, where both the light source 13 and detector 14 are located on the same side. The light is emitted from light source 13 into plastic optical sensing fiber 12, and is detected by detector 14 on the other end of the U shaped plastic optical sensing fiber 12.

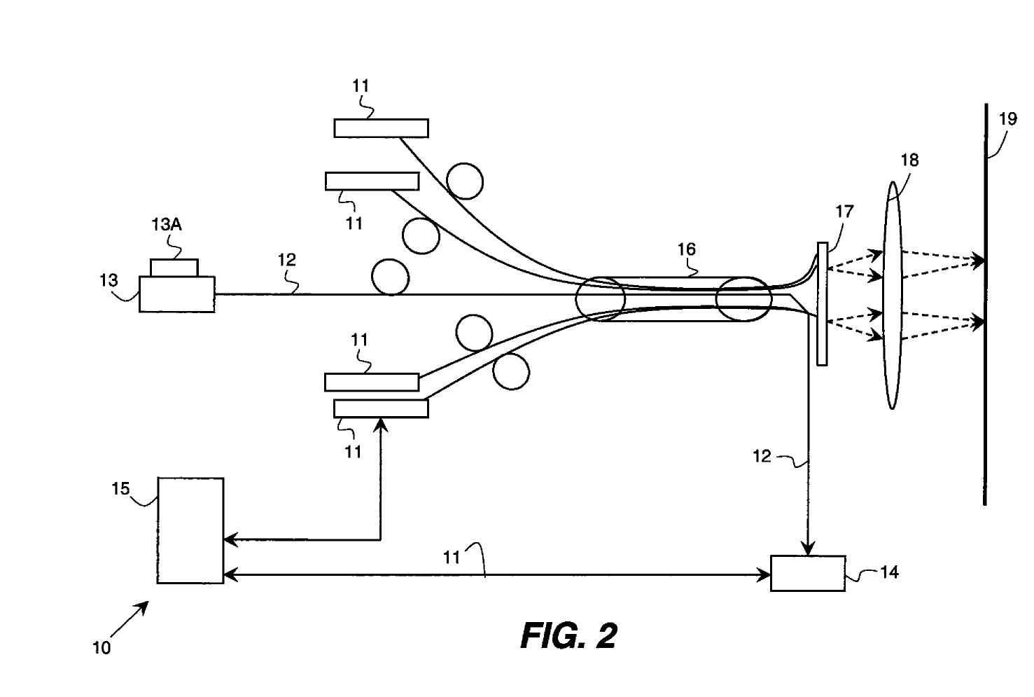

Another configuration is shown in FIG. 2, wherein light source 13 and detector 14 are located on opposite sides; light source 13 is located at the proximal tip of the fiber bundle 16 and the detector 14 at the distal tip of the bundle. More than one plastic optical sensing fiber 12 can be deployed in a single fiber bundle 16. Having more than a single plastic optical sensing fiber 12 may increase redundancy and reliability of the safety device.

The plastic optical sensing fiber 12 can be arranged along the fiber bundle 16 of glass fibers in plurality of configurations. For example, it can be twisted around fiber bundle 16 in a spiral or helical form, thereby increasing its spatial sensitivity to heat. Further more, the plastic optical sensing fiber 12 can be embedded within one of the bundle elements. For example, it can be embedded into the plastic tube that houses the bundle of the silica fibers. The sensing fiber can be also arranged in a fiber optic bundle without a tube comprising of at least one fiber optic waveguide.

The fiber bundle 16 distal ends are arranged into a fiber mechanical assembly 17. The emitted light through fiber mechanical assembly 17 is imaged by imaging lens 18 onto plate 19. Light source 13 is coupled into the proximal tip of plastic optical sensing fiber 12 and is detected by detector 14 the distal end of plastic optical sensing fiber 12. Light source 13 includes photodiode 13A, which is coupled into the proximal tip of the plastic optical sensing fiber 12.

The photodiode 13A helps to verify that the light source 13 is working properly. In the case where photodiode 13A senses that light source 13 works properly and that detector 14 located at the distal end of plastic optical sensing fiber 12 does not sense any light. This fact will indicate that plastic optical sensing fiber 12 melt due to temperature excess, and that a cut, a break, a crack, or any other malfunction of and along the glass fibers caused a fire. As a result the plastic optical sensing fiber 12, which is characterized by a low predefined temperature melting point, will melt and will activate interlock 15 setting an alarm and causing the high power fiber coupled laser diodes 11 to shutdown.

The wavelength, coupled into and transmitted by the plastic optical sensing fiber 12 can differ from the wavelength emitted by the high power fiber coupled laser diodes 11 and coupled into the silica fibers. For example, a 680 nm wavelength can be used for fiber 12 and 915 nm for high power fiber coupled laser diodes 11. A well defined wavelength used in conjunction with plastic optical sensing fiber 12 detected by detector 14, will ensure that the detected wavelength is not a result of a leakage from a possibly broken high power fiber coupled laser diodes 11.

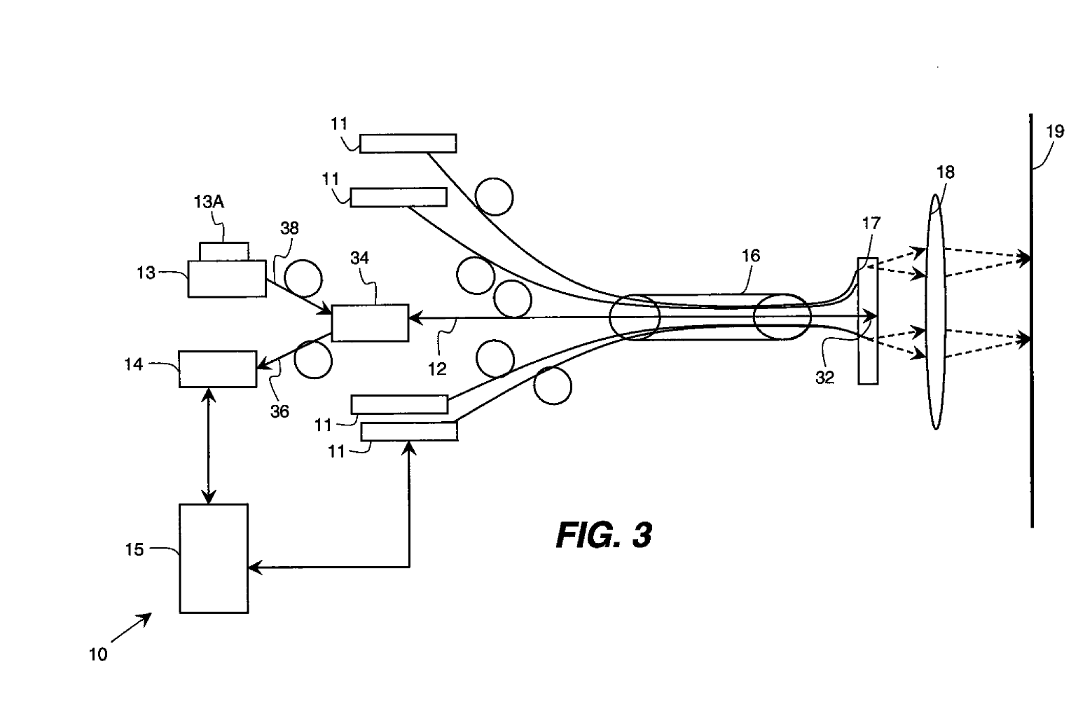

FIG. 3 illustrates another embodiment of this invention. This embodiment can be used, for example, in cases where a U shaped fiber configuration, described by FIG. 1, is not feasible, since the bent radius of optical fibers is limited. In this embodiment a fiber optic coupler 34 is used. Light source 13 emits light via fiber connecting light source and coupler 38 into plastic optical sensing fiber 12 through fiber optic coupler 34. The light is back reflected from the distal tip of the plastic optical sensing fiber 12 due to the Fresnel reflection into fiber connecting coupler and detector 36 through fiber optic coupler 34 and is detected by detector 14. In order to enhance the reflection, the fiber tip reflective coating 32 of plastic optical sensing fiber 12 is coated with a reflecting coating such as metal or based on a thin film technology.

The present invention safety device utilizing plastic fiber optic distributed temperature sensor 10 can be configured to sense excess heat and alert on hazardous situations in various devices. For example, along a link incorporating high power transmitting optical fibers, or a link of electrical cables.

The invention has been described in detail with particular reference to certain preferred embodiments thereof, but it will be understood that variations and modifications can be effected within the scope of the invention.

### PARTS LIST

10 temperature sensor
11 high power fiber coupled laser diodes
12 plastic optical sensing fiber
13 light source
13A photodiode
14 detector
15 interlock
16 fiber bundle
17 fiber mechanical assembly
18 imaging lens
19 plate
32 fiber tip reflective coating
34 fiber optic coupler
36 fiber connecting coupler and detector
38 fiber connecting light source and coupler

1. A distributed temperature sensor for cables configuration comprising:
at least one optical waveguide wherein said waveguide is embedded within said cables configuration is selected from material with a desired melting point and wherein said desired melting point is lower than the melting points of all other elements comprising said cables configuration;
a light source configured to emit light into said optical waveguide; and
a detector configured to detect transmitted light intensity from said optical waveguide.

2. The distributed temperature sensor according to claim 1 further comprising:
an alert module configured to alert on light degradation or light level detected from said optical waveguide.

3. The distributed temperature sensor according to claim 1 wherein an interlock module is configured to perform shutdown of a high power laser diode emitting light into said cable.

4. The distributed temperature sensor according to claim 1 further comprising:
an interlock module configured to perform a shutdown when light degradation or no light is detected by said detector.

5. The distributed temperature sensor according to claim 4 wherein said interlock module is configured to perform shutdown of a high power laser diode emitting light into said cable.

6. The distributed temperature sensor according to claim 1 wherein said optical waveguide is a circular optical fiber.

7. The distributed temperature sensor according to claim 1 wherein said optical waveguide is constructed from plastic.

8. The distributed temperature sensor according to claim 1 wherein said optical waveguide is laid along said cable.

9. The distributed temperature sensor according to claim 1 wherein said optical waveguide is wrapped inside said cable.

10. The distributed temperature sensor according to claim 1 wherein said optical waveguide is embedded within or around said cable.

11. The distributed temperature sensor according to claim 5 wherein said light source emits light in a wavelength different than the light emitted by said high power laser diode.

12. The distributed temperature sensor according to claim 1 wherein said cable is a fiber optic bundle.

13. The distributed temperature sensor according to claim 1 wherein said cable is an electronic cable bundle.

14. The distributed temperature sensor according to claim 2 wherein a predefined time dependent light degradation profile sets the alert or activates the interlock.
